(19) United States
(12) Patent Application Publication
(10) Pub. No.: US 2025/0241327 A1
(43) Pub. Date: Jul. 31, 2025

(54) EVISCERATION WEIGHING SYSTEM

(71) Applicant: BAADER Food Systems USA Inc., Kansas City, KS (US)

(72) Inventors: Dustin Wesley DOHERTY, Olathe, KS (US); Ryan Wesley O'DELL, Weatherby Lake, MO (US); Ryan John FOLTZ, Bucyrus, KS (US); Gerald Kent LAUER, Lee's Summit, MO (US); Patrick John SCHLOTTER, Harrisonville, MO (US); Douglas Bryan BARNETT, Olathe, KS (US)

(73) Assignee: BAADER Food Systems USA Inc., Kansas City, KS (US)

(21) Appl. No.: 19/040,647

(22) Filed: Jan. 29, 2025

Related U.S. Application Data
(60) Provisional application No. 63/626,832, filed on Jan. 30, 2024.

(51) Int. Cl. A22C 21/06; A22C 21/00; G01G 17/00; G01G 21/23

(52) U.S. Cl. CPC A22C 21/06; A22C 21/0046; G01G 17/00; G01G 21/23

(57) ABSTRACT

An evisceration weighing system includes a frame portion and a rotatable portion. The frame portion includes a first weigh plate and a second weigh plate, with the rotatable portion rotatably mounted with respect to the frame portion. The rotatable portion includes a first support arm pivotally mounted to the rotatable portion capable of applying a force to the first weigh plate that is indicative of a weight of a first poultry carcass supported by the first support arm, and a second support arm pivotally mounted to the rotatable portion capable of applying a force to the second weigh plate that is indicative of a weight of a second poultry carcass supported by the second support arm. The evisceration weighing system is capable of weighing the first poultry carcass at the same time as the second poultry carcass.

### CROSS-REFERENCE TO RELATED APPLICATIONS

This application claims priority in U.S. Patent Application Ser. No. 63/626,832, filed Jan. 30, 2024, the contents of which are hereby incorporated by reference in its entirety.

### BACKGROUND

### 1. Field of the Disclosed Subject Matter

The invention relates generally to equipment for mechanically processing poultry. More particularly, the invention relates to an evisceration weighing system for poultry processing.

### 2. Background

Poultry is typically processed in a highly automated manner. Poultry carcasses are typically moved along a poultry processing line suspended from shackles. The shackles enable the poultry carcasses to be securely retained in the poultry processing line while the poultry carcasses are quickly moved using the poultry processing line.

An example of one shackle is set forth in Criscione, II et al., U.S. Pat. No. 8,864,558. The shackle engages a portion of the poultry carcass such as the legs to securely move the poultry carcasses through the poultry processing line.

One factor in processing poultry is the size of the carcass as it is typically more efficient to process using equipment that is adapted for the size of the poultry carcass that is being processed on the equipment.

Rather than measuring the size of the poultry carcass, it has been found that it is easier and quicker to measure the weight of the poultry carcass as the weight of the poultry carcass is indicative of the size of the poultry carcass within a given breed or flock.

One typical location for weighing the poultry carcasses is after the evisceration step because that provides an accurate indication of the size of the poultry carcass prior to the poultry carcass moving to additional processing steps such as chilling. There is currently no solution to accurately weigh the poultry carcass when it remains attached to a shackle as it is moving from the evisceration step to the chilling step.

### SUMMARY

An embodiment of the invention is directed to an evisceration weighing system that includes a frame portion and a rotatable portion. The frame portion has a first weigh plate and a second weigh plate. The rotatable portion that is rotatably mounted with respect to the frame portion. The rotatable portion includes a first support arm and a second support arm. The first support arm is pivotally mounted in the rotatable portion. The first support arm is capable of applying a force to the first weigh plate that is indicative of a weight of a first poultry carcass supported by the first support arm. The second support arm is pivotally mounted in the rotatable portion. The second support arm is capable of applying a force to the second weigh plate that is indicative of a weight of a second poultry carcass supported by the second support arm. The evisceration weighing system is capable of weighing the first poultry carcass at the same time as the second poultry carcass.

Another embodiment of the invention is directed to a method of using an evisceration weighing system. A frame portion is provided that includes a first weigh plate and a second weigh plate. A rotatable portion is rotatably mounted with respect to the frame portion. The rotatable portion includes a first support arm and a second support arm that are both pivotally attached to the rotatable portion. A first poultry carcass is supported on the first support arm. A first force is applied to the first weigh plate with the first support arm. The first force is indicative of a weight of the first poultry carcass. A second poultry carcass is supported on the second support arm. A second force is applied to the second weigh plate with the second support arm. The second force is indicative of a weight of the second poultry carcass. The evisceration weighing system is capable of weighing the first poultry carcass at the same time as the second poultry carcass.

### BRIEF DESCRIPTION OF THE DRAWINGS

The present disclosed subject matter is described herein with reference to the following drawing figures, with greater emphasis being placed on clarity rather than scale:

FIG. 1 is a perspective view of an evisceration weighing system according to an embodiment of the invention.

FIG. 2 is front view of the evisceration weighing system.

FIG. 3 is a side view of the evisceration weighing system.

FIG. 4 is an upward view of the evisceration weighing system.

FIG. 5 is an enlarged upward perspective view of the evisceration weighing system.

FIG. 6 is an enlarged upward perspective view of the evisceration weighing system of FIG. 5 showing the cam assembly.

FIG. 7 is an elevation view of FIG. 6.

FIG. 8 is a rear elevation view of the cam assembly.

FIG. 9 is a perspective view of a support arm for the evisceration weighing system.

FIG. 10 is a side elevation view of FIG. 9.

FIG. 11 is a front elevation view of FIG. 9.

FIG. 12 is a side elevation view of an implementation of a support arm for the evisceration weighing system.

FIG. 13 is a perspective view of an implementation of a support arm for the evisceration weighing system.

FIG. 14 is a front elevation view of FIG. 13.

FIG. 15 is a front elevation view from above of FIG. 13.

FIG. 16 is a side elevation view of FIG. 13.

FIG. 17 is a representation of resolving the bird weight into components parallel and normal to the support arm.

### DETAILED DESCRIPTION

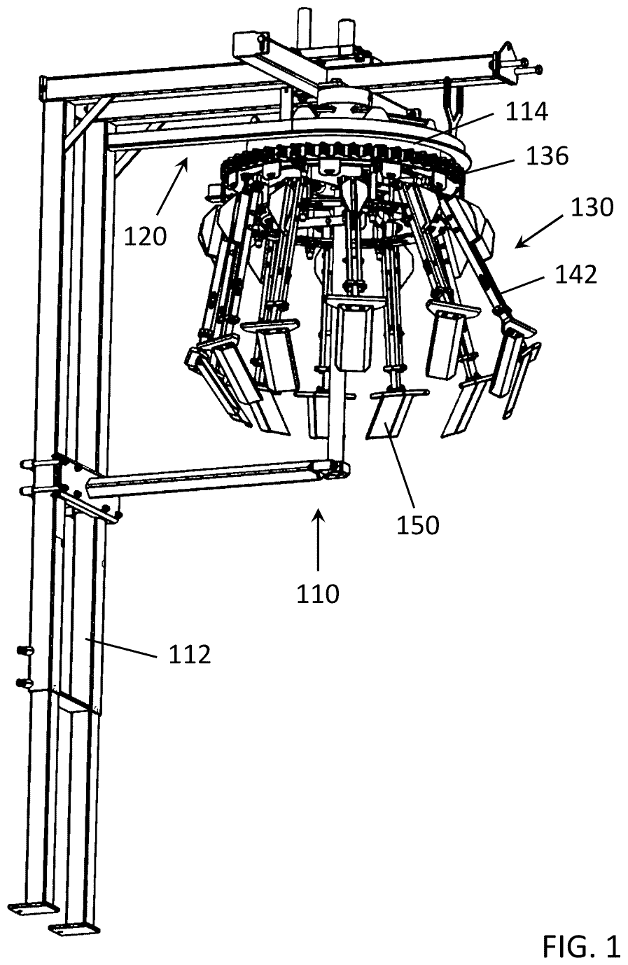

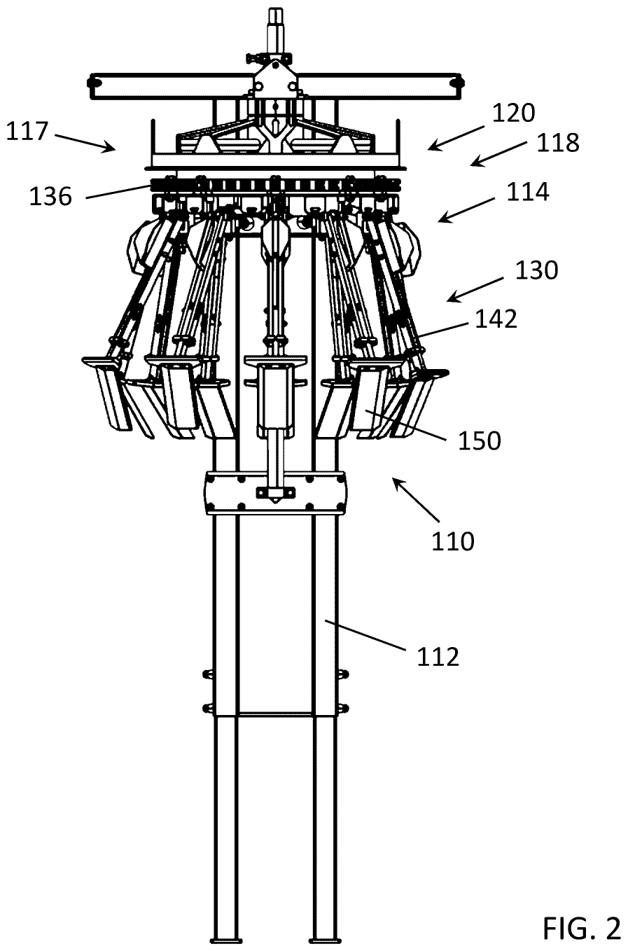

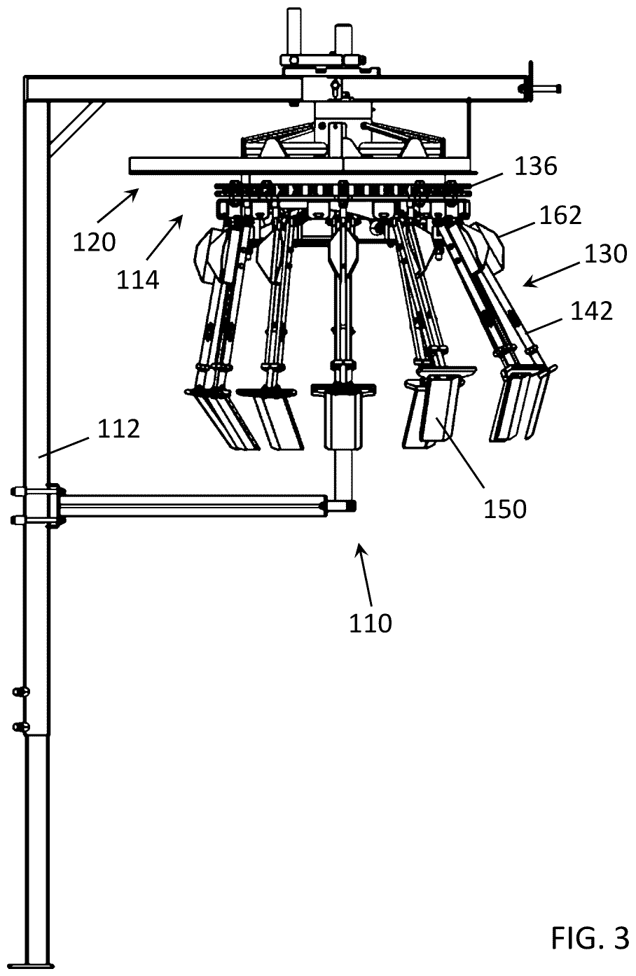

An embodiment of the disclosed subject matter is directed to an evisceration weighing system as illustrated at 110 in FIGS. 1-5. The evisceration weighing system 110 enables the weight of an eviscerated poultry carcass to be quickly and accurately measured. In certain embodiments, the evisceration weighing system 110 simultaneously weighs two poultry carcasses. A person of skill in the art will appreciate that the concepts may be adapted to simultaneously weigh more than two poultry carcasses.

While it is desired for an evisceration weighing system 110 to quickly determine the weight of the poultry carcasses, it is also highly desirable for the poultry carcasses to be accurately weighed. Additionally, it is highly undesirable to decrease the rate at which the poultry carcasses move through the evisceration weighing system 110 to increase the accuracy of the poultry carcass weight.

In certain embodiments, the weighing of the poultry carcasses is done after evisceration of the poultry carcasses and prior to chilling of the poultry carcasses. However, it is possible for the concepts to be adapted for weighing the poultry carcasses at other points in the poultry processing line. It is also possible to adapt the concepts of the disclosed subject matter for use in conjunction with other objects that are processed at relatively fast rates in a processing line.

The evisceration weighing system 110 thereby enables the poultry carcasses to be directed to particular processing equipment based upon the weight of the poultry carcasses because the weight of the poultry carcass, which is indicative of the size of the poultry carcasses.

In one configuration, the evisceration weighing system 110 is configured so that the poultry processing line enters the evisceration weighing system 110 in a first direction 104 and exits the evisceration weighing system 110 in a second direction 106 that is about one hundred eighty degrees from the first direction.

The evisceration weighing system 110 generally includes a ground engaging frame portion 112 and a rotatable portion 114 that is rotatably mounted with respect to the frame portion 112. The frame portion 112 may be formed with sufficient rigidity to not only support the evisceration weighing system 110 but also the shackles and the poultry carcasses that engage with the evisceration weighing system 110.

The poultry carcasses are attached to shackles such as having a configuration that is similar to what is illustrated in Criscione II, et al., U.S. Pat. No. 8,864,558. The shackles move in the evisceration weighing system 110 by a chain and trolley system that rides on a rail 120, and the chain and trolley system engages a sprocket assembly 136 attached to the frame portion 112 the shackles enter the evisceration weighing system 110 at an entrance area 117, and exit the system 110 at an exit area 118. As the poultry carcass enters the evisceration weighing system 110 from the first direction 104 they move beneath the trolley traveling on the rail 120. The sprocket assembly 136 is driven by the chain and trolley system to rotate the weighing system 110. A person of skill in the art will appreciate that the sprocket assembly 136 may have a variety of configurations and that the engagement between the shackles and the sprocket assembly 136 may have a variety of configurations using the embodiments of the disclosed subject matter.

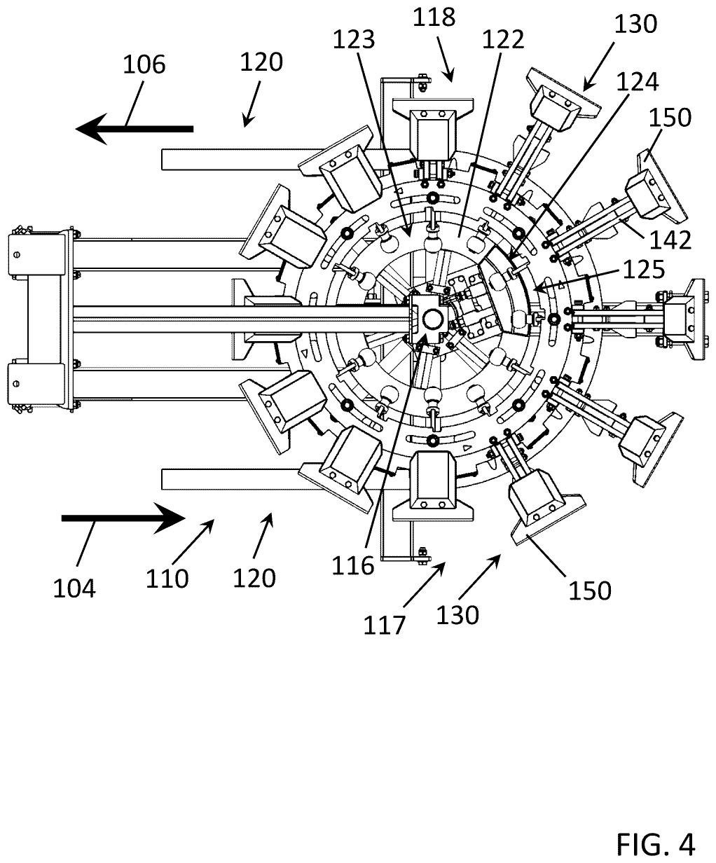

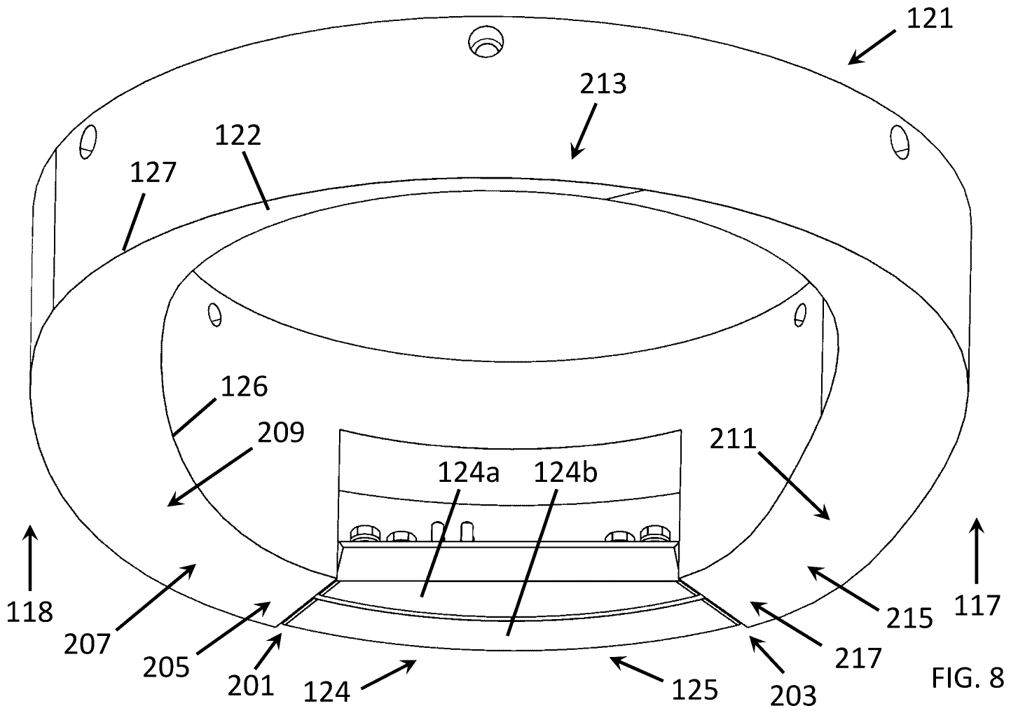

The frame portion 112 has a cam assembly 121 mounted thereto. As illustrated in FIGS. 4-9, the cam assembly 121 forms a cam surface 122 forming differing height regions that cause pivoting of support arms 130 as is described in more detail herein.

In certain embodiments, the cam assembly 121 includes a change in elevation relative to a weigh section 124. The cam surface 122 includes a first segment 123 and a second segment 125. In an implementation, the first segment 123 is a semicircle extending from a first end 201 to a second end 203, bound by an inner edge 126 and an outer edge 127. The second segment 125 is disposed between the first end 201 and second end 203. The cam surface 122 of the first segment 123 forms a first landing 205 at the first end 201 adjacent the weighing section 124 whereby the cams surface 122 forms a downward facing surface. The cam surface 122 forms a first slope 207 extending upward, away from the first end 201, whereby both the outer edge 127 and inner edge 126 extend upward from the first landing 205, with the inner edge 126 elevated relative to the outer edge 127 at a first transition zone 209. As a result, the cam surface 122 formed between the first landing 205 and the first transition zone 209 transition from a downward facing surface to an inwardly angled surface, with the inner edge 126 elevated relative to the outer edge 127. The cam surface 122 extends from the first transition zone 209 to a second transition zone 211, forming a return segment 213 with the cam surface 122 having an inwardly angled surface. The cam surface 122 forms a second slope 215 extending downward away from the return segment 213 toward the second end 203, whereby both the outer edge 127 and inner edge 126 extend downward from the return segment 213 to a second landing 217 at the second end 203 where both the outer edge 127 and inner edge 126 arrive at the same level at the second landing 217, whereby the cam surface 122 forms a downward facing surface.

The cam surface 122 is configured so that on opposite sides of the cam surface 122 of the first landing 205 and second landing 277 provide a smooth transition between the first segment 123 and the second segment 125. In an implementation, the weigh section 124, the height of the cam surface 122 is approximately equal to the height of the surface of the weigh section 124. This configuration minimizes movement of the poultry carcasses that are entering the weighing region as such movement could decrease the accuracy of the weighing process.

The weigh section 124 is used in measuring the weight of the poultry carcasses as the poultry carcasses are moving in the evisceration weighing system 110. Forming the weigh section 124 with the increased height causes the poultry carcass to be positioned outward from beneath the rail 120. In an implementation, the poultry carcass is at least partially on a stabilization surface 150, which reduces movement of the poultry carcass during the weighing process and thereby enhances accuracy of the weighing process.

In certain embodiments, the change in elevation between the cam surface 122 of the weigh section 124a and the cam surface 122 of the return section 213 is at least approximately 1.5 times the height of the cam surface 122 of the return section 213.

The cam surface 122 has a semi-circular shape that extends over a first angle or first segment 123 as illustrated in FIGS. 4-9. The weigh section 124 has a semi-circular shape that extends over a second angle or second segment 125. A sum of the first angle and the second angle is 360 degrees.

The degree angle of the second segment 125 is determined based upon the number of support arms 130 that are attached to the rotatable portion 114. In certain embodiments where the evisceration weighing system 110 includes twelve support arms 130, as shown in the figures, the second segment 125 over which the weigh section 124 extends outward from beneath the rail 120 is about 60 degrees. Therefore, the first angle over which the first segment 123 extends is about 300 degrees.

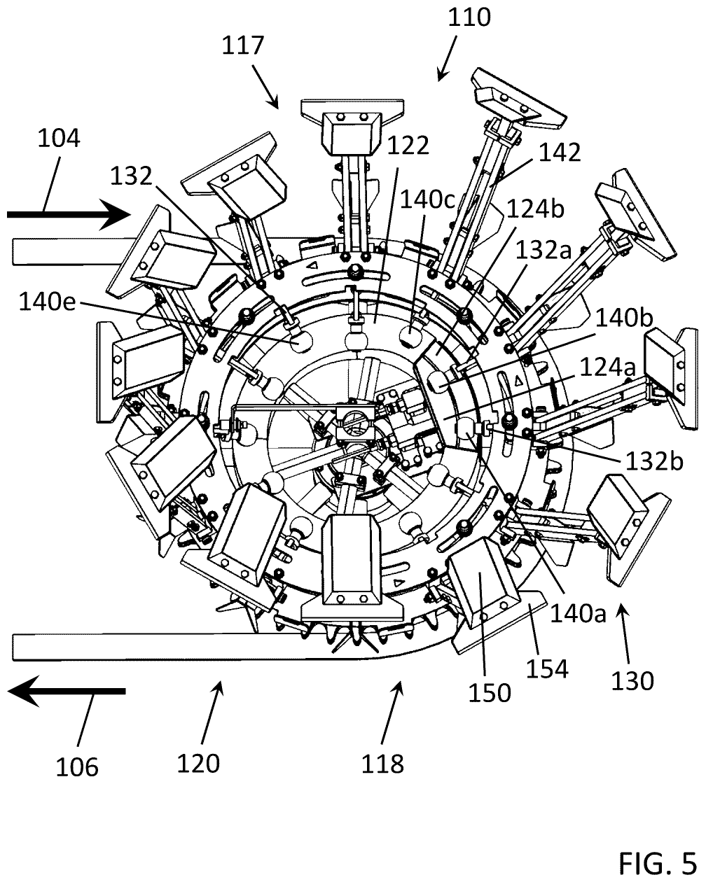

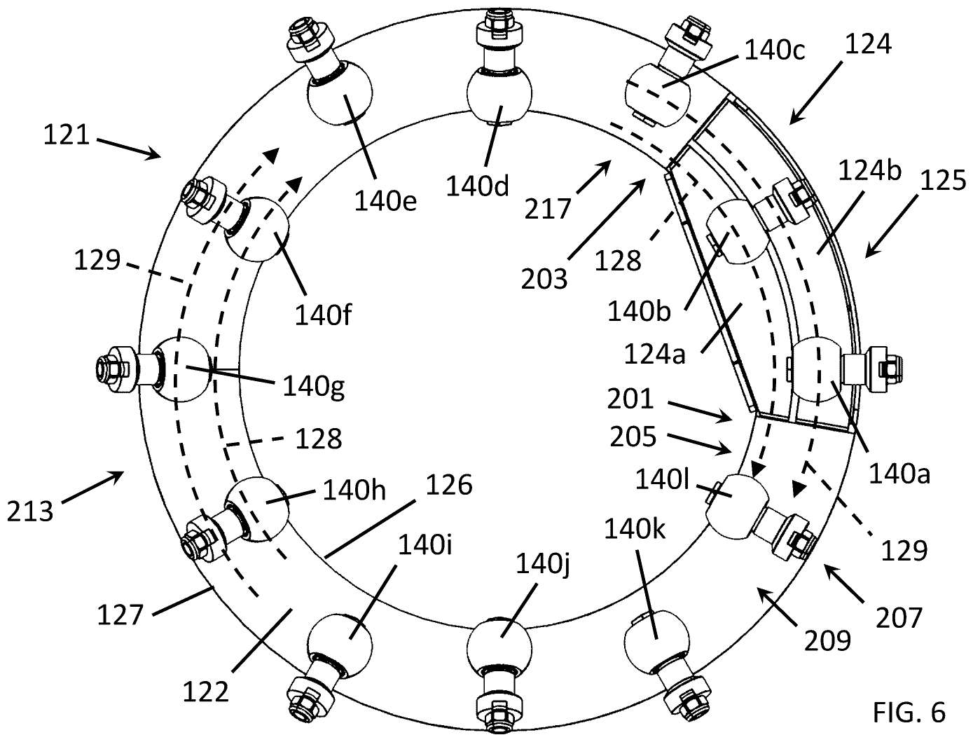

The weigh section 124 includes a first weigh plate 124a, forming a first weigh segment, and a second weigh plate 124b, forming a second weigh segment, as illustrated in FIGS. 5-6. Each weigh plate 124a, 124b is operably connected to a weight sensing device, such as a load cell, for measuring the force applied to the weigh plate 124a, 124b, by the roller 140 of the support arms (described below). Forming the weigh section 124 in two sections facilitates simultaneously weighing two poultry carcasses while increasing the accuracy of the weighing because the weighing can be done over a longer period of time. The invention increases the volume of poultry carcasses that can be processed using the evisceration weighing system 110.

The first weigh plate 124a is located at a first distance from a rotational axis 116 of the rotatable portion 114. The second weigh plate 124b is located at a second distance from the rotational axis of the rotatable portion 114. The first distance is smaller or less than the second distance, whereby the first weigh plate 124a is located between the rotational axis 116 and the second weigh plate 124b.

In certain embodiments, a width of the first weigh plate 124a is approximately equal to a width of the second weigh plate 124b. In certain embodiments, the combined width of the first weigh plate 124a and the second weigh plate 124b is approximately equal to the width of the cam surface 122.

The rotatable portion 114 is mounted for rotation with respect to the frame portion 112. In certain embodiments, the rotation is about a generally vertically oriented axis. A variety of techniques may be used to control rotation of the rotatable portion 114. The rotatable portion 114 includes a sprocket assembly 136 that is mounted thereto. In certain embodiments, the sprocket assembly 136 includes a plurality of teeth that extend from an edge of the sprocket assembly 136. The teeth engage the chain attached to the trolleys and the shackles that are attached to it, thereby driving the rotatable portion 114 controlling the rate at which the shackles move through the evisceration weighing system 110. The chain is typically driven by an electric motor (not shown) that drive similar sprocket assemblies at one or several points throught the associated processing line.

The evisceration weighing system 110 includes a plurality of the support arms 130 operably attached thereto. The number of support arms 130 is selected based upon factors such as the rate at which poultry carcasses that are desired to be processed on the evisceration weighing system 110. In certain embodiments, there are between 8 and 32 support arms 130. In other embodiments, there are 12 support arms 130.

Each of the support arms 130 includes a proximal section 132 and a distal section 134. The support arms 130 are pivotally mounted to the rotatable portion 114 intermediate the support arm proximal section 132 and the support arm distal section 134 by a bracket 131 and joint 133. The bracket 131 is connected to a ring, and the ring is connected to the rotatable portion 114.

The support arm proximal section 132 includes a roller 140 that is operably attached to a proximal end thereof. In certain embodiments, the roller 140 may have a generally spherical configuration. Such a configuration may enhance the ability of the roller 140 to contact the cam surface 122 and the weigh section 124 regardless of the orientation of the support arms 130.

The support proximal sections 132 either have a first length or a second length where the first length is longer than the second length. The first proximal sections 132a are formed with a first length so that the rollers 140 attached to the first proximal sections 132a are in contact with the first weigh plate 124a. The second proximal sections 312b are formed with a second length so that the rollers 140 attached to the second proximal sections 132b are in contact with the second weigh plate 124b. The support arms 130 are mounted so that the first proximal sections 132a alternate with the second proximal sections 132b as illustrated in FIG. 5, resulting in the rollers 140 attached thereto to track accordingly across the first weigh plate 124a and second weigh plate 124b, respectively.

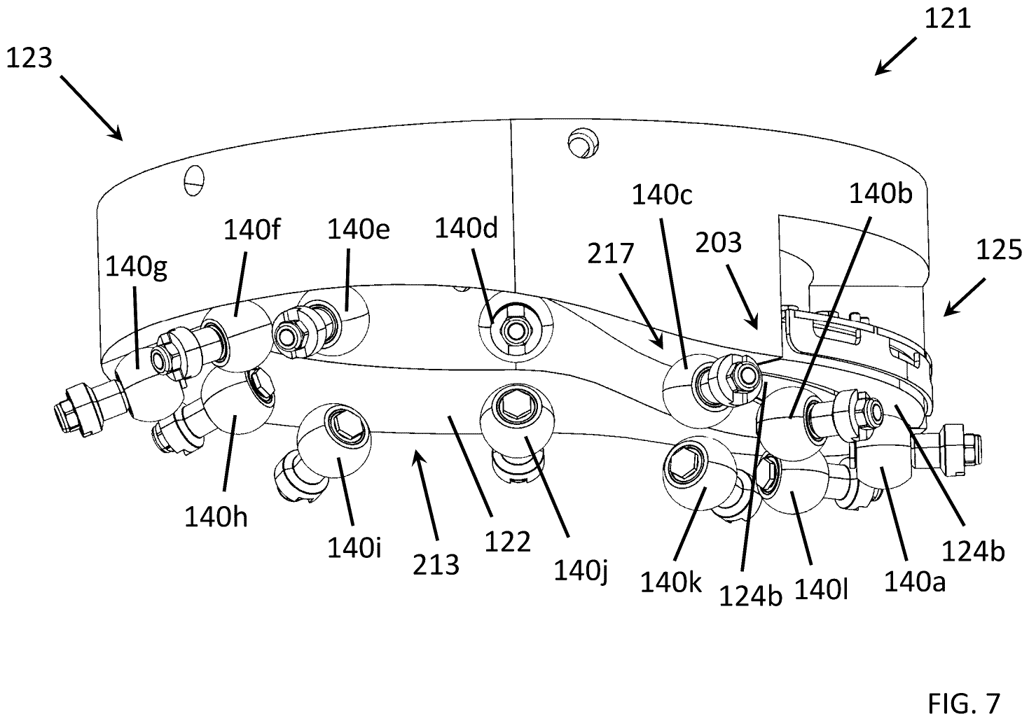

Referring to FIGS. 6-7, an arrangement of rollers 140 relative to an arrangement of alternating first proximal sections and second proximal sections is shown. Rollers 140 attached to proximal sections 132 having a first length follow a first path 128 clockwise about the cam surface 122, and rollers 140 attached to proximal sections 132 having a second length follow a second path 129 clockwise about the cam surface 122. For example, where the system 110 includes twelve support arms 130, six of the rollers 140 follow the first path 128 (rollers 140b, 140d, 140f, 140h, 140j, and 140l), and six of the rollers 140 follow the second path 129 (rollers 140a, 140c, 140e, 140g, 140i, and 140k).

The support arm distal section 134, which is illustrated in FIG. 6, has an elongated shape that is selected based upon the length of the shackles. In certain embodiments, the length of the support arm distal section 134 may be adjusted such that the evisceration weighing system 110 may be used in conjunction with shackles having different lengths.

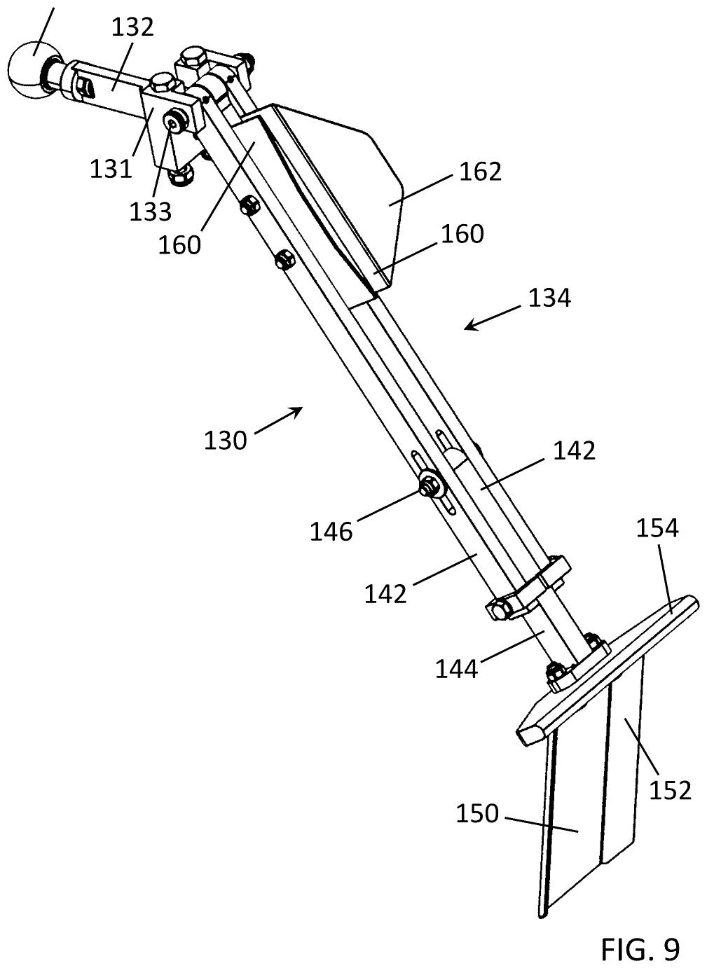

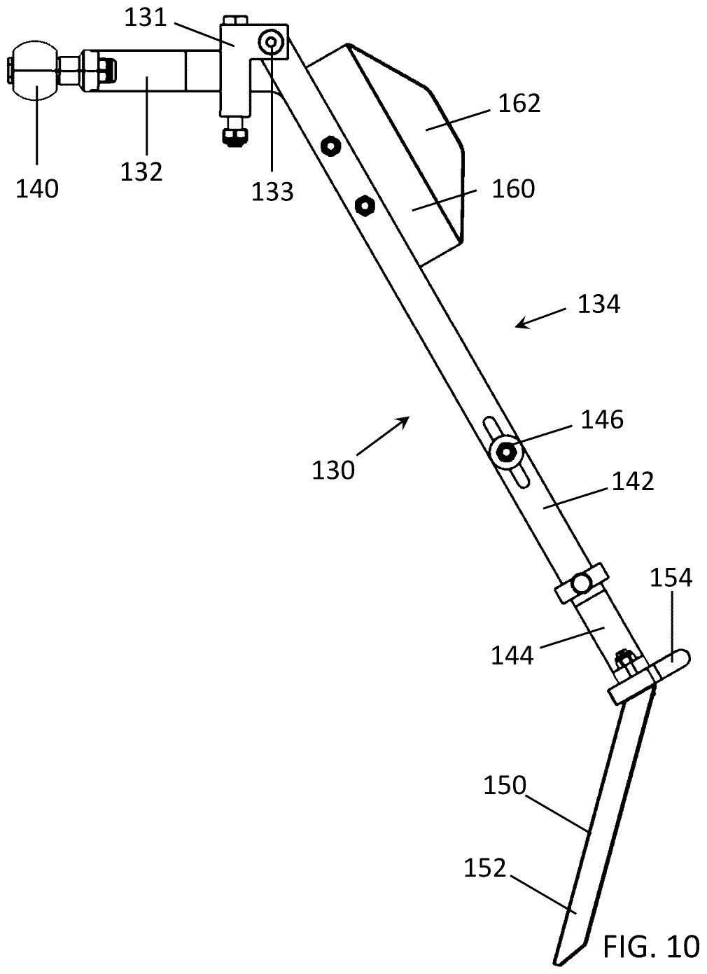

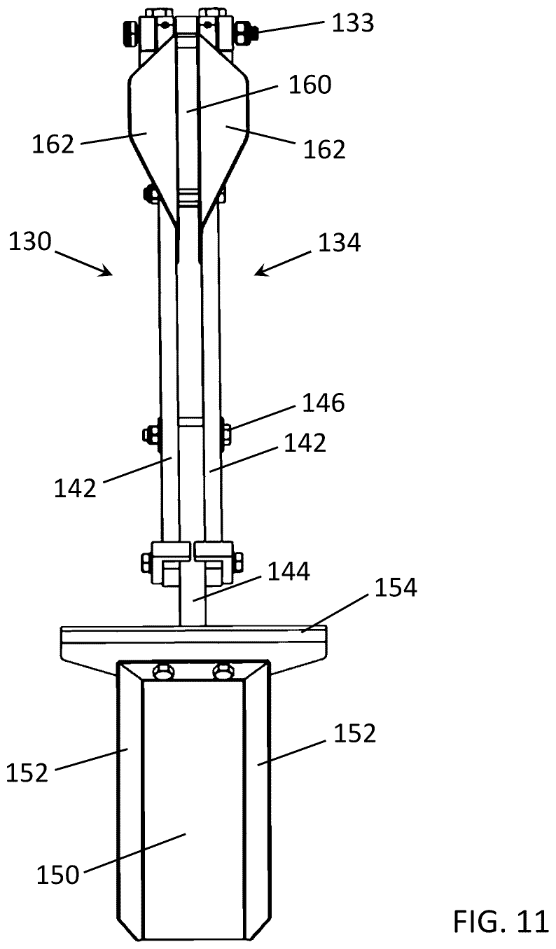

Referring to FIGS. 9-11, an implementation of the support arm 130 is shown. The support arm distal section 134 generally includes at least one first elongated member 142 that is mounted in a spaced-apart configuration so that a second elongated member 144 may be positioned between the first elongated members 142. The second elongated member 144 is slidably mounted with respect to the first elongated members 142 to change a length of the support arm distal end 134.

A variety of techniques may be used to retain the second elongated member 144 in a stationary position with respect to the first elongated members 142. An example of one suitable technique is a bolt 146.

Proximate a first end thereof, the support arm distal section 134 has a stabilization surface 150 attached hereto. In certain embodiments, the stabilization surface 150 is formed with a length and a width that are similar to the length and the width of the poultry carcass such that the poultry carcass can be supported on the stabilization surface 150.

Side support panels 152 may be provided along at least one side edge of the stabilization surface 150. The side support panels 152 may be formed with a length that is similar to the length of the stabilization surface 150.

A width of the side support panels 152 may be smaller than the width of the stabilization surface 150. In certain embodiments, the width of the side support panels 152 is between about ten percent and about fifty percent of the width of the stabilization surface 150. In other embodiments, the width of the side support panels 152 is about twenty-five percent of the width of the stabilization surface 150.

The side support panels 152 are oriented at an obtuse angle with respect to the stabilization surface 150. The stabilization surface 150 and the side support panels 152 thereby provide a concave region that is adapted to receive at least a portion of the poultry carcass during the weighing process. This configuration reduces movement of the poultry carcass while the poultry carcass is being weighed, which enhances the accuracy of the weighing process.

The stabilization surface 150 is mounted at an angle of between about 180 degrees and about 270 degrees with respect to the second elongated members 144. In certain embodiments the angle between the stabilization surface 150 and the outer elongated members 142 is about 225 degrees. Mounting the stabilization surface 150 at this angle further reduces movement of the poultry carcass with respect to the stabilization surface 150 during the weighing process.

Intermediate the second elongated member 144 and the stabilization surface 150, an elongated support 154 may be provided. In certain embodiments, the elongated support 154 may be oriented generally perpendicular to second elongated member 144. The elongated support 154 may have a width that is larger than the width of the stabilization surface 150. The elongated support 154 may have an upper surface that is elevated above the upper surface of at least one of the second elongated member 144 and the stabilization surface 150. During the weighing process, a portion of the shackle may rest on the elongated support 154 to reduce movement of the shackle during the weighing process and thereby enhance the accuracy of the weighing process.

Proximate a second end of the support arm distal section 134 a guide channel 160 is provided. The guide channel 160 is formed with a width that is similar to a width of the portion of the shackles that is proximate the guide channel 160. Using such a configuration further reduces movement of the shackles during the weighing process. This configuration also enhances the ability to retain the poultry carcass on the stabilization surface 150 during the weighing process.

The guide channel 160 may include outwardly flared sides 162 to enhance the ability to direct the shackle into the guide channel 160. In certain embodiments, the flared sides 162 are oriented at an obtuse angle with respect to the other portions of the guide channel 160.

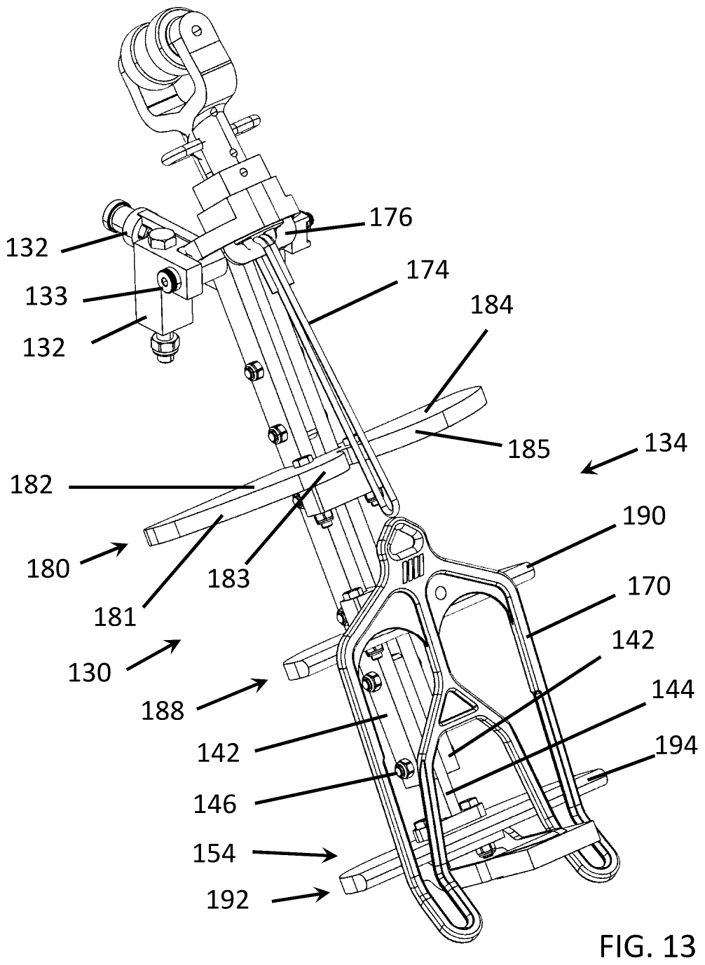

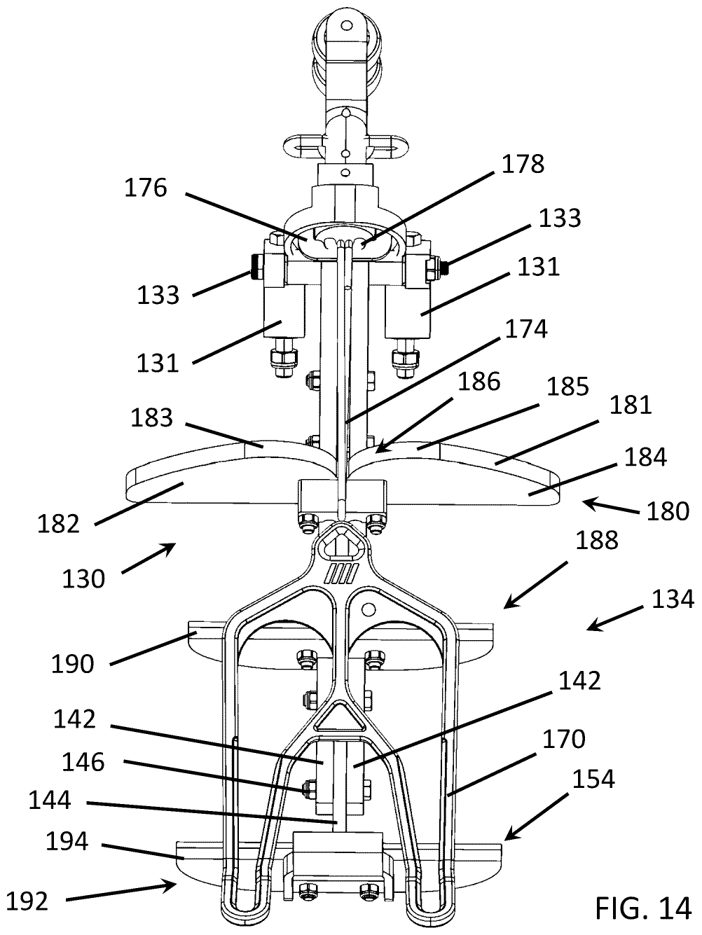

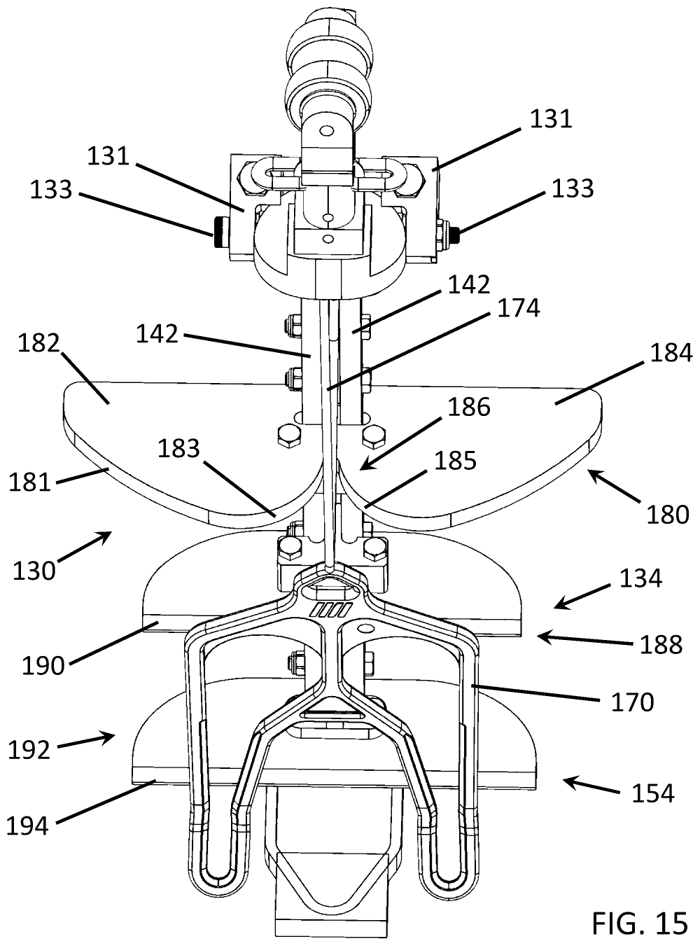

Referring to FIGS. 13-16, an implementation of the support arm 130 is shown. The distal section 134 includes a middle support 188 between an upper support 180 and lower support 192. The lower support 192 forms an upper contact surface 194 that supports a lower portion of the shackle 170. The middle support 188 forms an upper contact surface 190 for supporting an upper portion of the shackle 170. The upper support 180 forms a receiver 186 between a first wing 182 and adjacent second wing 184. The wings 182, 184 form an upper contact surface 181. The receiver 186 forms depression in the middle of the upper support 180, and the depression extends upward and away from a bottom wall proximate the first elongated member 142, forming adjacent sidewalls 183, 185 that extend upward and laterally from the elongated members 142, forming a curved upper contact surface 181. The sidewalls 183, 185 provide a concave region that is adapted receive the drop rod 174. The configuration of the receiver 186 reduces movement of the captured drop rod 174 during the weighing process to enhance the ability to retain the poultry carcass 172 on the support surfaces 180, 188, and 192, and to decrease movement of the poultry carcass 172 to minimize movement that causes variability in the measured weights.

In operation, the poultry carcasses 172 are each hung on shackles which are attached to a chain for movement in a poultry processing line. The poultry carcasses are moved towards the evisceration weighing system 110 where the shackle rides along the chain.

Because of the speed at which the poultry carcasses 172 are moved in the poultry processing line, it is common for the poultry carcasses to be swinging both in the machine direction and perpendicular to the machine direction. This swinging motion presents challenges for accurately weighing the poultry carcasses such that the poultry carcasses can be directed to appropriate processing equipment based upon the size of the poultry carcasses.

Upon entering the evisceration weighing system 110, the chain engages the teeth on the sprocket assembly 136 so that the shackle is aligned with one of the support arms 130. As the rotatable portion 114 rotates, the roller 140 moves along the cam surface 122 which causes the support arm 130 to pivot outwardly.

This pivoting motion causes the upper part of the shackle to move into the guide channel 160 or receiver 186 to reduce swinging of the poultry carcass 172 in the machine direction as well as perpendicular to the machine direction.

Further pivoting of the support arm 130 causes the poultry carcass 172 to be positioned proximate the stabilization surface 150 between the side support panels 152 in the implementation shown in FIGS. 9-12, which substantially stops swinging motion of the poultry carcass such that the poultry carcass can be accurately weighed.

Another benefit of the pivoting of the support arms 130 is that the poultry carcasses are spaced further apart during the weighing process. In certain embodiments, the spacing between poultry carcasses as they enter the evisceration weighing system 110 is about eight inches. After the outward pivoting of the support arms 130, the spacing between adjacent poultry carcasses may be about sixteen inches.

This greater spacing between the poultry carcasses reduces the potential of the poultry carcasses contacting each other during the weighing process as such contact would degrade the accuracy of the poultry carcass weighing.

Rotation of the rotatable portion 114 continues until the roller 140a is on the second weigh plate 124b. The force of the roller 148a on the second weigh plate 124b is indicative of the weight of the poultry carcass, at the associated support arm 130. Rotation of the rotatable portion 114 also causes the roller 140b to be on the first weigh plate 124a. The force of the roller 140b on the first weigh plate 124a is indicative of the weight of the poultry carcass at the associated support arm 130.

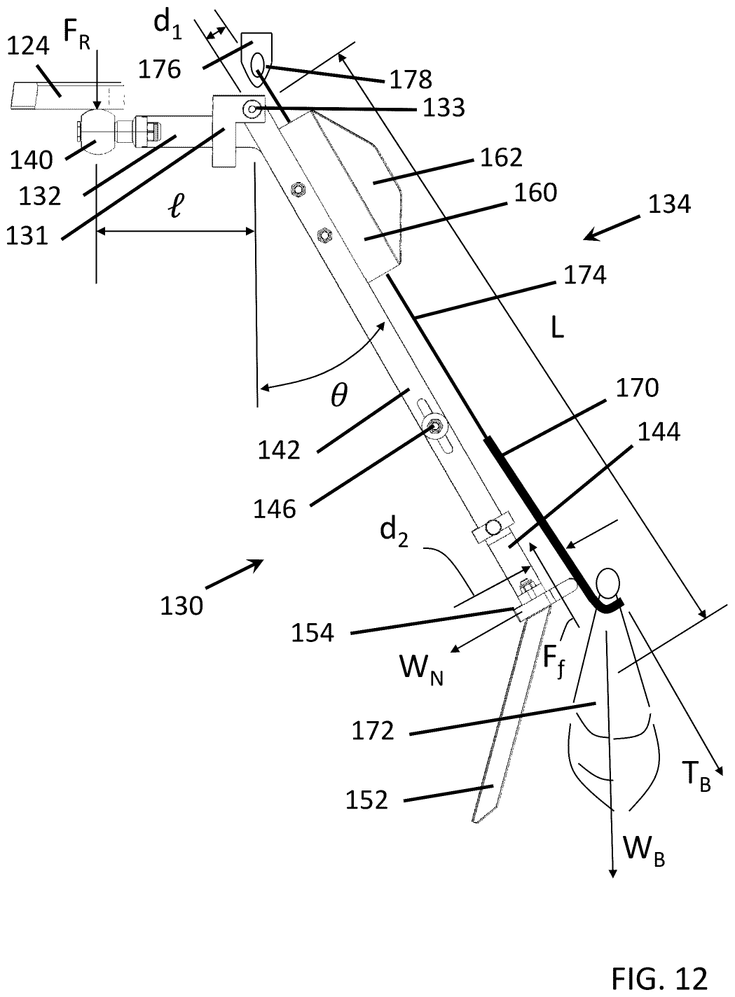

The weight of the poultry carcasses as the rollers 140a and 140b move along the weigh plates 124b and 124a is determined using a formula that incorporates distances and angles. Referring to FIG. 12, an implementation of the weighing of the poultry carcass is shown. The shackle 170 moves into the evisceration weighing system 110 in the first direction 104 attached to the trolley 176 by a drop rod 174. The trolley 176 rides on the rail 120 using wheels (not shown), and the roller 140 (rollers 140a and 140b) engages the weighing section 124 (weigh plates 124b and 124a, respectively).

Referring to FIGS. 12 and 16, the weight of the poultry carcass/bird 172 (referred to as W_{B}), is calculated based on the formula

$${W}_{B} = ( \frac{ℓ}{L sin θ} ) {F}_{R} .$$

The variable [symbol] is the distance between the pivot joint 133 and the roller 140 contact point with the weighing section 124; the variable L is the distance between the pivot joint 133 and the engagement of the shackle 170 with the lower support (the elongated support 154 in FIGS. 9-12; the lower support 192 in FIGS. 13-16); the variable θ is the tilt angle between a vertical line bisecting the pivot joint 133 and the first elongated member 142; and the variable F_{R} is the measured force as measured by the weighing section 124, and thus the weight sensing device.

Additional variables include: the variable d₁ for the distance between a line parallel with the first elongated member 142 bisecting the pivot joint 133 and a line parallel to the first elongated member 142 bisecting the aperture 178 for connecting the drop rod 174 to the trolley 176; the variable d₂ for the distance between the shackle 170 and support arm 130; the variable W_{N} for the weight normal value; the variable F_{f} for the force friction; and the variable T_{B} for the tension in the drop rod 174 and shackle 170 assembly.

Additional calculations involved in the system, include:

$$Σ M = 0 = ℓ * {F}_{R} - {d}_{1} * {T}_{B} - L * {W}_{N} + {d}_{2} {F}_{f}$$

$${d}_{1} \to 0 {d}_{2} \to 0$$

$$0 = ℓ * {F}_{R -} L * {W}_{N}$$

$$0 = ℓ * {F}_{R -} L * {W}_{B} sin θ$$

$$L * {W}_{B} sin θ = ℓ {F}_{R}$$

$$K = ( \frac{ℓ}{L sin θ} )$$

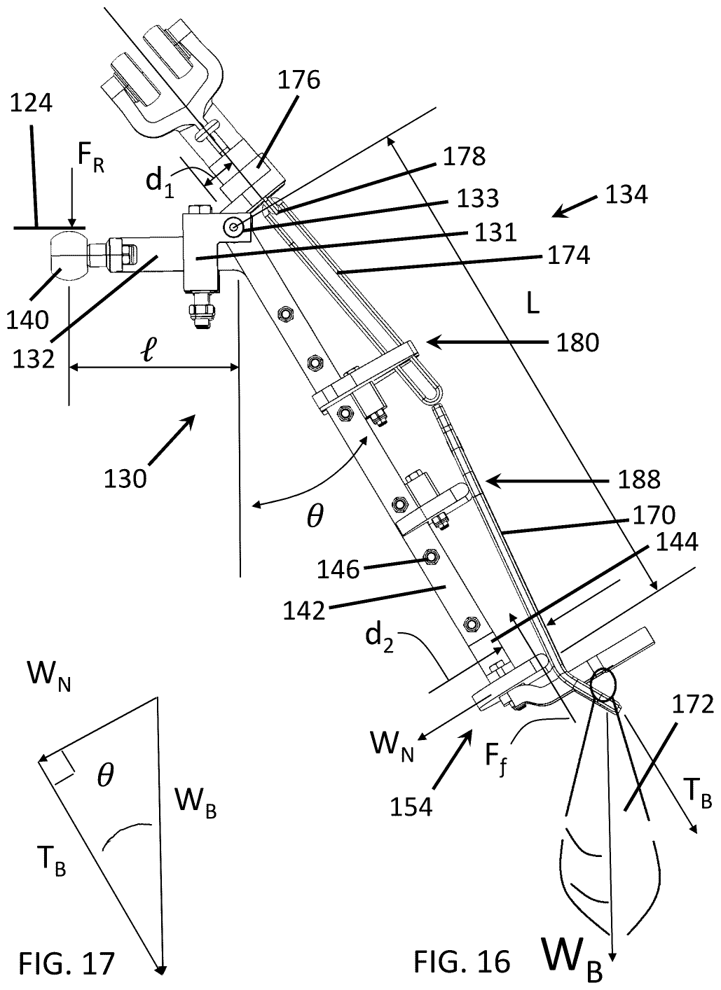

Due to the design of the system, variables [symbol] , L, and θ resolve to be consistent values, and thus constants in the calculation of the weight of the bird (W_{B}) that do not change, or vary minimally so as to not affect the ultimate calculation. In addition, the system design results in the variables d₁ and d₂ essentially being negligible or zero, removing those values from the overall calculation, simplifying the calculations necessary to arrive at the weight of the poultry carcass/bird 172 (W_{B}) (FIG. 17).

Through this system and weighing process, the length of time that the roller 140b is on the first weigh plate 124a and the length of time that the roller 140a is on the second weigh plate 124b (i.e., dwell time) is twice as long as compared to if there was only a single weigh section. This increased time of the contact between the roller 140b on the first weigh plate 124a and the roller 140a on the second weigh plate 124b enables the weight of the poultry carcasses to be more accurately measured.

The continued rotation of the rotatable portion 114 moves the roller 140 from on the weigh section 124 to on the cam surface 122 and the cam surface 122 decreases in height which enables the support arms 130 to pivot inward so that the poultry carcass and the associated shackle are hanging as opposed to being supported by aspects of the support arm 130. The poultry carcasses are then moved to other sections of the poultry processing line such as classification based upon size and then chilling.

Having described the disclosed subject matter, what is claimed as new and desired to be secured by Letters Patent is:

1. An evisceration weighing system comprising:
a frame portion comprising:
a first weigh plate; and
a second weigh plate; and
a rotatable portion that is rotatably mounted with respect to the frame portion, wherein the rotatable portion comprises:
a first support arm pivotally mounted to the rotatable portion, wherein the first support arm is adapted to apply a force to the first weigh plate that is indicative of a weight of a first poultry carcass supported by the first support arm; and
a second support arm pivotally mounted to the rotatable portion, wherein the second support arm is adapted to apply a force to the second weigh plate that is indicative of a weight of a second poultry carcass supported by the second support arm and wherein the evisceration weighing system is capable of weighing the first poultry carcass at the same time as the second poultry carcass.

2. The evisceration weighing system of claim 1, comprising:
wherein the rotatable portion is rotatable about a rotational axis;
wherein the first weigh plate is located at a first distance from the rotational axis;
wherein the second weigh plate is located at a second distance from the rotational axis; and
wherein the first distance is less than the second distance.

3. The evisceration weighing system of claim 1, wherein the frame portion further comprises a cam surface that is adapted to pivot the support arms in the rotatable portion.

4. The evisceration weighing system of claim 3, comprising:
wherein the cam surface has a semi-circular shape that extends over a first angle;
wherein the first weigh plate and the second weigh plate each have a semi-circular shape that extends over a second angle; and
wherein a sum of the first angle and the second angle is 360 degrees.

5. The evisceration weighing system of claim 4, comprising:
wherein the first angle is about 300 degrees; and
wherein the second angle is about 60 degrees.

6. The evisceration weighing system of claim 1, comprising:
wherein the first support arm further comprises:
a support arm proximal section that comprises a roller adapted to engage the first weigh plate; and
a support arm distal section that comprises a support surface adapted to support the first poultry carcass; and
wherein the second support arm further comprises:
a support arm proximal section that comprises a roller adapted to engage the second weigh plate; and
a support arm distal section that comprises a support surface adapted to support the second poultry carcass.

7. The evisceration weighing system of claim 6, comprising:
wherein the first support arm distal section further comprises:
an elongated member to which the support surface is attached; and
a guide channel mounted to the elongated member, wherein the guide channel is adapted to receive at least a portion of a shackle to which the first poultry carcass is attached; and
wherein the second support arm distal section further comprises:
an elongated member to which the support surface is attached; and
a guide channel mounted to the elongated member, wherein the guide channel is adapted to receive at least a portion of a shackle to which the second poultry carcass is attached.

8. The evisceration weighing system of claim 1, comprising:
wherein the evisceration weighing system comprises six of the first support arms;
wherein the evisceration weighing system comprises six of the second support arms; and
wherein the first support arms and the second support arms are provided in an alternating configuration.

9. The evisceration weighing system of claim 1, comprising:
wherein the frame portion further comprises a chain; and
wherein the first poultry carcass and the second poultry carcass are each operably movable with respect to the chain using a shackle.

10. A method of using an evisceration weighing system, comprising:
providing a frame portion comprising a first weigh plate and a second weigh plate;
rotatably attaching a rotatable portion to the frame portion, wherein the rotatable portion comprises a first support arm and a second support arm that are both pivotally attached to the rotatable portion;
supporting a first poultry carcass on the first support arm;
applying a first force to the first weigh plate with the first support arm, wherein the first force is indicative of a weight of the first poultry carcass;
supporting a second poultry carcass on the second support arm; and
applying a second force to the second weigh plate with the second support arm, wherein the second force is indicative of a weight of the second poultry carcass and wherein the evisceration weighing system is adapted to weighing the first poultry carcass at the same time as the second poultry carcass.

11. The method of claim 10, and further comprising:
rotating the rotatable portion about a rotational axis;
positioning the first weigh plate at a first distance from the rotational axis; and
positioning the second weigh plate at a second distance from the rotational axis, wherein the first distance is less than the second distance.

12. The method of claim 10, and further comprising pivoting the first support arm and the second support arm using a cam surface mounted to the frame portion.

13. The method of claim 12, comprising:
wherein the cam surface has a semi-circular shape that extends over a first angle;
wherein the first weigh plate and the second weigh plate each have a semi-circular shape that extends over a second angle; and
wherein a sum of the first angle and the second angle is 360 degrees.

14. The method of claim 13, comprising:
wherein the first angle is about 300 degrees; and
wherein the second angle is about 60 degrees.

15. The method of claim 10, and further comprising:
engaging the first weigh plate with a first roller that is operably attached to a proximal section of the first support arm; and
engaging the second weigh plate with a second roller that is operably attached to a proximal section of the second support arm.

16. The method of claim 10, and further comprising:
supporting the first poultry carcass with a first support surface attached to a distal section of the first support arm; and
supporting the second poultry carcass with a second support surface attached to a distal section of the second support arm.

17. The method of claim 16, wherein the frame portion further comprises a chain and wherein the method further comprises:
operably mounting the first poultry carcass to the chain using a first shackle;
providing a guide channel on the first support arm distal section; and
positioning at least a portion of the shackle in the guide channel to restrict movement of the first poultry carcass on the first support surface.

18. The method of claim 10, comprising:
wherein the evisceration weighing system comprises a plurality of the first support arms;
wherein the evisceration weighing system comprises a plurality of the second support arms; and
wherein the first support arms and the second support arms are provided in an alternating configuration.
